(19) United States
(12) Patent Application Publication
(10) Pub. No.: US 2004/0078120 A1
(43) Pub. Date: Apr. 22, 2004

(54) Non-linear compensation of a control system having an actuator and a method therefore

(76) Inventors: Edgar Melkers, Oxford, CT (US); Vineet Sahasrabudhe, Hamden, CT (US)

Correspondence Address: CARLSON, GASKEY & OLDS, P.C., 400 WEST MAPLE ROAD, SUITE 350, BIRMINGHAM, MI, 48009, US

(21) Appl. No.: 10/271,466

(22) Filed: Oct. 16, 2002

(51) Int. Cl. G06F 17/00

(52) U.S. Cl. 701/3; 244/175

(57) ABSTRACT

A control system compensation algorithm which operates as a comparator of a nominal state and unlimited dynamic state of an actuator. Upon reaching either rate or position saturation, the difference between the nominal state actuator model and the unlimited dynamics actuator model is the excess command signal of an uncompensated actuator command which would put the actuator into saturation. The excess command is then filtered to the designed system bandwidth. The filtered excess servo command from filter is then subtracted from the original uncompensated actuator command signal to generate the rate limited actuator command.

### BACKGROUND OF THE INVENTION

The present invention relates to a control system, and more particularly to an actuator limit protection compensation algorithm based on an actuator frequency response having rate/position limits for controlling the pilot's input to the aircraft's flight control system to eliminate pilot-induced oscillations.

Control systems typically include physical actuators, e.g., electrical motors, hydraulic servo valves, etc. These actuators all have position and rate limits due to limits in power supply, hydraulic pressure, etc. Control systems therefore inherently include restrictions with regard to the rate at which a new command from the driver of the vehicle, i.e., a change in the input signal into the control system, can give rise to corresponding changes in the physical output signal from the control system. If the time derivative for the input signal exceeds a certain value, the time derivative for the output signal is limited in relation to the time derivative for the input signal. That is, the output signal is subject to a time delay in relation to the input signal. This phase shift leads to impairment of the performance of the vehicle and, in the worst case, may give rise to instability.

In aircraft applications, a PIO (Pilot Induced Oscillation) may occur when unforeseen circumstance causes the pilot to execute rapid and/or large control stick movements. The phase shift that occurs because of the rate limitation of the control system amplifies the oscillations. In some conditions, the oscillations may become divergent, which may result in loss of control. In an effort to prevent PIOs from arising, aircraft control systems are stringently designed and tested under a variety of conditions. Nonetheless, even with such intensive design and test efforts, aircraft and/or pilot behavior may lead to PIOs.

Accordingly, it is desirable to provide a control system which prevent PIOs at their onset before they become overly serious.

### SUMMARY OF THE INVENTION

The control system according to the present invention provides an algorithm which provides compensation as a comparator of a nominal state and unlimited dynamic actuator model. As long as the nominal state actuator model does not come up against a non-linearity in the system, e.g., rate saturation and/or position saturation, the nominal state actuator model and the unlimited dynamics actuator model cancel each other. The feedforward algorithm under nominal operation therefore does not affect the frequency and time domain characteristics of the control system.

Upon reaching either rate or position saturation, the difference between the nominal state actuator model and the unlimited dynamics actuator model is the excess command signal of an uncompensated actuator command which puts the actuator into saturation. The excess command is then filtered to the designed system bandwidth. The filtered excess servo command from the filter is then subtracted from the original uncompensated actuator command signal to generate the rate limited actuator command.

Another system according to the present invention includes a degraded state actuator model and selection logic. Under certain conditions, actuators are known to become severely rate limited caused by, for example only, extreme flight loads, uncontrolled flight conditions, battle damage, or the like. Under such degraded conditions, one or more degraded state actuator models represents the degraded capabilities of the actuator. The compensation algorithm will therefore compensate a wide range of actuator operating conditions.

The present invention therefore provides a control system which prevent PIOs at their onset before they become overly serious.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a schematic block diagram of a control system of the present invention;

FIG. 2 is a schematic block diagram of another control system of the present invention; and

FIG. 3 is a graphical representation of a filtered output from a bandwidth model for a control system of the present invention.

### DETAILED DESCRIPTION OF THE PREFERRED EMBODIMENT

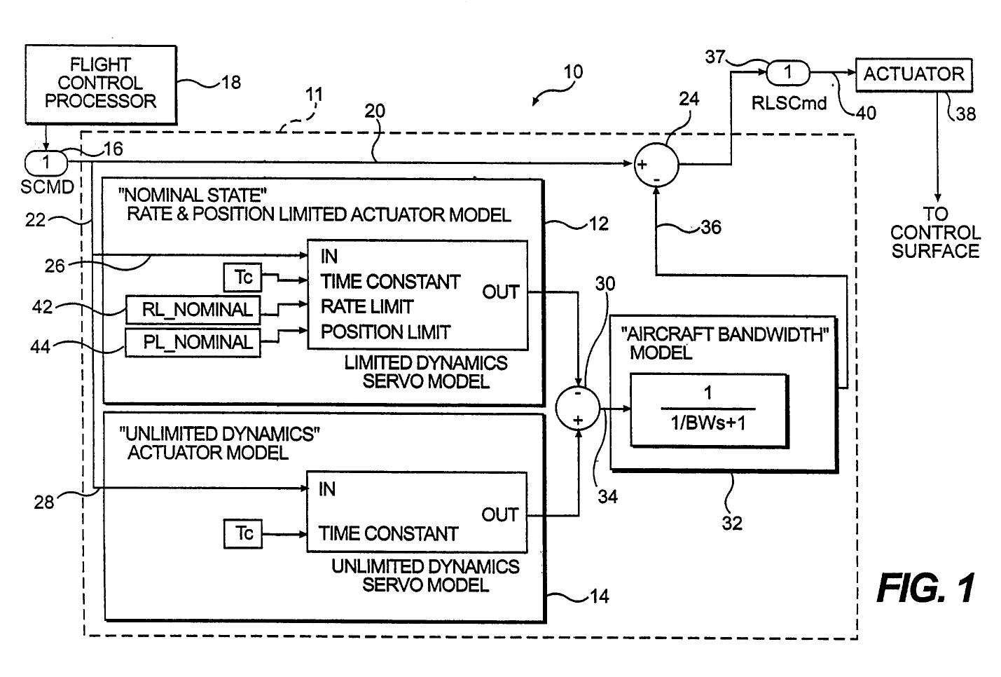

FIG. 1 illustrates a general block diagram of a control system 10 such as flight control system. The control system generally comprises a feedforward algorithm 11 based on the control system actuator performance characteristics which detects the imminent onset of actuator rate and position limiting, and removes any excess signal from the command path while operating up to maximum selected bandwidth. It should be understood that various control systems including vehicle and non-vehicle based control systems will benefit from present invention and although encompassing a preferred embodiment, the present invention is not limited to flight control systems.

The control system 10 includes a compensation algorithm 11 including a nominal state actuator model 12 and an unlimited dynamics actuator model 14 running in parallel. An uncompensated actuator command signal 16 from a flight control processor (illustrated schematically at 18) is communicated forward on line 20 and line 22. It should be understood that other command generation systems will also benefit from the present invention. From line 20, the uncompensated actuator command signal 16 is communicated to a first summing junction 24. From line 22, the uncompensated actuator command signal 16 is split into each model 12, 14 on lines 26 and 28 respectively. The output of each model 12, 14 is compared at a second summing junction 30 and the excess command is communicated to a filter 32 on line 34. The filtered signal is communicated to summing junction 24 on line 36. The output of summing junction 24 is a rate limited actuator command 37 which is communicated to an actuator 38 such as a servo, an electrohydraulic servovalve (EHSV) a direct drive servo valve, or other actuation device on line 40.

The nominal state actuator model 12 simulates the normal operating characteristics of the actuator 38. That is, nominal state actuator model 12 simulates how the actuator 38 responds during nominal operation. The nominal state actuator model 12 preferably includes a rate limit (illustrated schematically at 42) and a position limit (illustrated schematically at 44) of the actuator 38 at predefined nominal operating conditions. All actuators have rate limits which are the maximum rate at which the actuator can extend or retract. All actuators also have position limits which represent the maximum actuator travel. Rate limits are critical design specifications which have a direct effect on flight control system performance.

Rate limiting is often cited as a contributing factor to PIO phenomenon, in which the pilot plus aircraft closed loop system dynamics become unstable. The limits 42, 44 are preferably obtained from system testing and design specifications, however, frequency response and limits 42, 44 of the actuator 38 may additionally or alternatively be estimated through Kalman filters or other modeling algorithms. That is, the limits 42, 44 may themselves be modeled.

The unlimited dynamics actuator model 14 simulates the actuator 38 as an ideal actuator which responds exactly to the uncompensated actuator command signal 16 without concern for rate and position limits. That is, whatever the flight control processor 18 commands, the unlimited dynamics actuator model 14 simulates the perfect response.

As long as the nominal state actuator model 12 does not come up against a non-linearity in the system, e.g., rate saturation and/or position saturation, the nominal state actuator model 12 and the unlimited dynamics actuator model 14 cancel each other. That is, the output of summing junction 30 is zero. The compensation algorithm 11 of the present invention under nominal operation therefore does not affect the frequency and time domain characteristics of the system 10.

Upon reaching either rate or position saturation, the difference between the nominal state actuator model 12 and the unlimited dynamics actuator model 14 is no longer zero. In fact, the output of summing junction 30 is the excess command signal of the uncompensated actuator command 16 which will put the actuator 38 into saturation. The excess command on line 34 is then filtered at filter 32 to a predetermined designed system bandwidth.

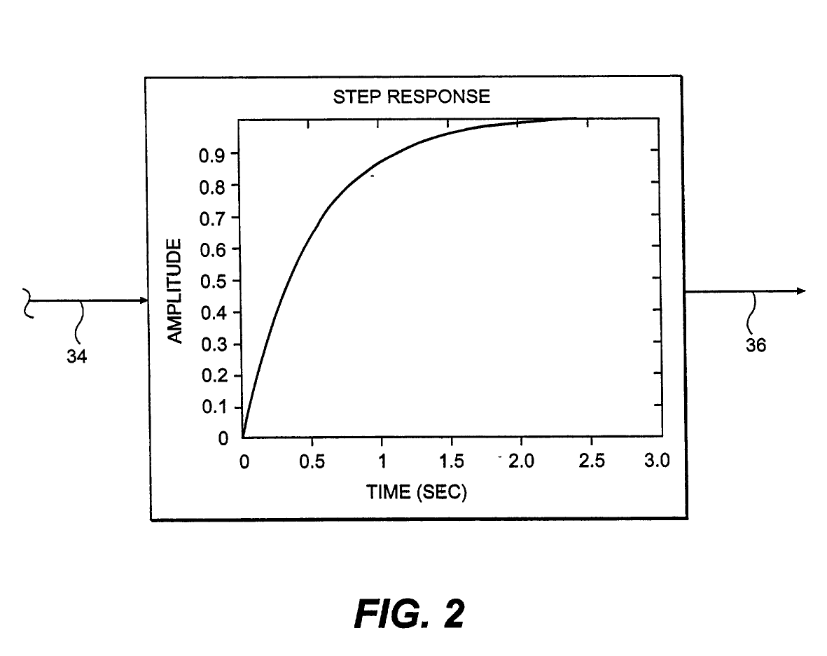

Filter 32 is preferably a lag filter which modifies the excess command on line 34 to ensure that the actuator 38 operates over the designed frequency range only, while not adding gain to the system over that provided by the original compensation. That is, the filter 32 filters the high frequency component of the excess command signal on line 34 to the designed system bandwidth. The filtered excess servo command from filter 32 (represented schematically as the output from a step input of 1; FIG. 2) is communicated to summing junction 24 on line 36 where it is subtracted from the original uncompensated actuator command signal 16 to generate the rate limited actuator command 37.

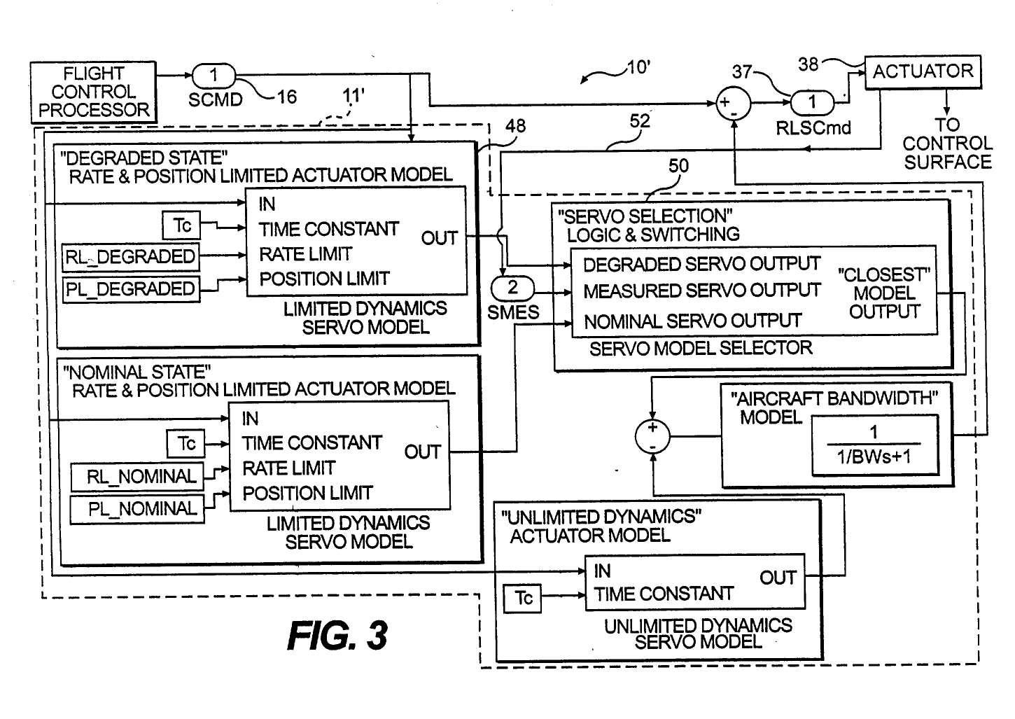

Referring to FIG. 3, another system 10′ provides a compensation algorithm 11′ according to the present invention which includes a degraded state actuator model 48 and selection logic (represented schematically at 50). Under certain conditions, actuators are known to become severely rate limited due to, for example only, extreme flight loads, uncontrolled flight conditions, battle damage, or the like. Under such degraded conditions, the FIG. 1 system may break down due to a relatively large difference between the nominal state actuator model 12 and the unlimited dynamics actuator model 14.

System 10′ provides one or more degraded state actuator models 48 (one schematically illustrated) to simulate the degraded capabilities of the actuator 38. For example only, typical electrohydraulic servovalves include primary and secondary hydraulic systems such that the degraded state actuator model 48 simulates operation of the actuator 38 when operating in response to only the secondary hydraulic system.

The selection logic 50 compares the measured output of the actuator 38 from line 52 with each the degraded state actuator models 48 and selects the degraded state actuator model 48 which best simulates actual actuator behavior. Although illustrated as communicating with the actuator 38, line 52 may alternatively or additionally communicate with an output such as a control surface which is driven by the actuator 38. The selected degraded state actuator models 48 is then utilized as describe with reference to FIG. 1 to remove excess actuator command from the uncompensated actuator command signal 16. Compensation algorithm 11′ will therefore compensate for a wide range of actuator operating conditions.

In practice, two models, a nominal actuator model and a degraded state actuator model, were sufficient to handle reasonable saturation situations, however, any number of degraded state actuator models will benefit from the present invention. Moreover, the degraded state actuator models need not be predetermined but may be calculated in response to a measured out put of the actuator to provide a sliding degraded state actuator model rather than a plurality of discrete degraded state actuator model.

Furthermore, it is understood that the present invention is not limited to a microprocessor based control system. The system may alternatively be implemented in a non-microprocessor based electronic system (either digital or analog).

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A control system comprising
a nominal state actuator model of an actuator, said nominal state actuator model in communication with an uncompensated actuator command;
an unlimited dynamics actuator model of said actuator, said unlimited dynamics actuator model in communication with said uncompensated actuator command; and
a filter communicating with said nominal state actuator model and said unlimited dynamics actuator model to filter a difference therebetween to generate a filtered difference and add said filtered difference to said uncompensated actuator command to generate a rate limited actuator command.

2. The control system as recited in claim 1, further comprising a degraded state actuator model in communication with said uncompensated actuator command.

3. The control system as recited in claim 2, further comprising a selection circuit which selects between said nominal state actuator model and said degraded state actuator model.

4. The control system as recited in claim 3, wherein said selection circuit selects between said nominal state actuator model and said degraded state actuator model in response to a measured output of said actuator.

5. The control system as recited in claim 3, wherein said selection circuit selects between said nominal state actuator model and said degraded state actuator model in response to a measured output of a control surface.

6. The control system as recited in claim 1, wherein said actuator comprises a flight control actuator.

7. The control system as recited in claim 1, further comprising a flight control processor which generates said uncompensated actuator command.

8. A method of controlling an actuator comprising the steps of:
(1) modeling a nominal state of the actuator;
(2) modeling an unlimited dynamic state of the actuator; and
(3) filtering a difference between said step (1) and said step (2) for an uncompensated actuator command; and
(4) summing the filtered difference from said step (3) with the uncompensated actuator command to generate a rate limited actuator command.

9. A method as recited in claim 8, wherein said step (1) further comprises a nominal rate limit of the actuator.

10. A method as recited in claim 9, further comprising the step of: estimating the nominal rate limit in response to a present actuator condition.

11. A method as recited in claim 8, wherein said step (1) further comprises a nominal position limit of the actuator.

12. A method as recited in claim 11, further comprising the step of estimating the nominal position limit in response to a present actuator condition.

13. A method as recited in claim 8, wherein said step (3) further comprises filtering a high frequency component of the difference between said step (1) and said step (2).

14. A method as recited in claim 8, wherein said step (3) further comprises filtering the difference between said step (1) and said step (2) to a predetermined system bandwidth.

15. A method as recited in claim 8, further comprising the steps of:
(a) modeling a degraded state of the actuator; and
(b) selecting between the nominal state actuator model and the degraded state actuator model in response to a measured output of the actuator.

16. A method as recited in claim 8, further comprising the steps of:
(a) driving the actuator in response to the rate limited actuator command;
(b) operating a flight control surface with the actuator.

17. A method of controlling a flight control system actuator comprising the steps of:
(1) modeling a nominal state of the actuator;
(2) modeling an unlimited dynamic state of the actuator; and
(3) filtering a difference between said step (1) and said step (2); and
(4) summing the filtered difference from said step (3) with the uncompensated actuator command to generate a rate limited actuator command.

18. A method as recited in claim 17, further comprising the steps of:
(a) modeling a degraded state of the actuator; and
(b) selecting between the nominal state actuator model and the degraded state actuator model in response to a measured output of the actuator.

19. A method as recited in claim 17, further comprising the steps of:
(a) driving the actuator in response to the rate limited actuator command; and
(b) operating a flight control surface with the actuator.

20. A computer readable storage medium containing a plurality of executable instructions for controlling an actuator, comprising:
a first set of instructions directing the computer to model a nominal state of the actuator;
a second set of instructions directing the computer to model an unlimited dynamic state of the actuator;
a third set of instructions directing the computer to filter a difference between the nominal state of the actuator and the unlimited dynamic state of the actuator for an uncompensated actuator command; and
a fourth set of instructions directing the computer to sum the filtered difference between the nominal state of the actuator and the unlimited dynamic state of the actuator for the uncompensated actuator command with the uncompensated actuator command to generate a rate limited actuator command.

21. The storage medium of claim 20, further comprising instructions directing the computer to model a degraded state of the actuator.

22. The storage medium of claim 21, further comprising instructions directing the computer to select between the nominal state actuator model and the degraded state actuator model in response to a measured output of the actuator
